(19) United States
(12) Patent Application Publication
(10) Pub. No.: US 2025/0308300 A1
(43) Pub. Date: Oct. 2, 2025

(54) SUSPENSION HEALTH MONITORING

(71) Applicant: PACCAR Inc, Bellevue, WA (US)

(72) Inventor: William Duley, Mount Vernon, WA (US)

(73) Assignee: PACCAR Inc, Bellevue, WA (US)

(21) Appl. No.: 18/617,220

(22) Filed: Mar. 26, 2024

(51) Int. Cl. G07C 5/08; B60W 50/029

(52) U.S. Cl. CPC G07C 5/0808; B60W 50/029; B60W 2050/0297; B60W 2510/22; B60W 2520/105; B60W 2710/22

(57) ABSTRACT

The present disclosure relates to systems and methods of providing suspension health monitoring in a vehicle according to examples. In examples, suspension health monitoring includes applying a machine learning (ML) model to collected sensor data for detecting patterns of behavior that can be correlated to a failing state of a component of the suspension system of the vehicle. The ML model may be trained to detect various stages of a failing state of one or more components. A failing state may be associated with a pattern of movement, vibration, temperatures, pressure variations, and/or another measurable characteristic of one or more drive axles and/or other monitored components as a result of the suspension system's response to a driving event. In some examples, a mitigation action is determined and performed to help mitigate the failing state and prevent further failure and/or performance and safety issues.

### BACKGROUND

An automotive suspension system is designed to support a vehicle chassis or body relative to a number of wheeled axles. The suspension system components work together to isolate the vehicle from the driving surface so as to provide desired ride and handling characteristics for different operating conditions. A failing or otherwise compromised suspension system component can negatively impact comfort, performance, and/or safety of the vehicle. It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This disclosure generally relates to providing suspension health monitoring. In examples, a suspension health monitor uses sensors to collect data about a vehicle's suspension and a machine learning and/or artificial intelligence (AI) model to analyze and assess the collected data. In further examples, the suspension health monitor triggers alerts or takes automated actions based on predefined thresholds for the suspension health status. Accordingly, suspension response behaviors that match a pattern of a failing state of a suspension system component may be detected in early phases of component fatigue or failure. Early detection of suspension health issues may improve driver safety and reduce vehicle down time.

According to an aspect, a vehicle is described, comprising: a chassis frame; a wheel and axle assembly comprising at least two axles and at least two sets of wheels; a suspension system connected to the chassis frame and the wheel and axle assembly; at least one sensor, comprising one of: a camera positioned to capture a view of at least one of the two axles; or an accelerometer attached to one of the two axles; and a suspension health monitor, comprising: at least one processing unit; and a memory including instructions, which when executed by the at least one processing unit, cause the suspension health monitor to: receive sensor data from the at least one sensor, where the sensor data captures a suspension response to a driving event; determine, using a machine-learning model, whether the suspension response correlates to a failing state of the suspension system; and when the suspension response is correlated to the failing state, perform a mitigation action based on the correlated failing state.

According to another aspect, a method for providing suspension health monitoring in a vehicle is described, comprising: receiving sensor data from at least one sensor, wherein: the at least one sensor comprises one of: a camera positioned to capture a view of at least one of two axles included in the vehicle; or an accelerometer attached to one of the two axles; and the sensor data captures a suspension response to a driving event; determining, using a machine-learning model, whether the suspension response correlates to a failing state of a suspension system of the vehicle; and when the suspension response is correlated to the failing state, performing a mitigation action based on the correlated failing state.

According to another aspect, a suspension health monitor is described, comprising: at least one processing unit; and a memory including instructions, which when executed by the at least one processing unit, cause the suspension health monitor to perform operations comprising: receiving sensor data from at least one sensor, wherein: the at least one sensor comprises one of: a camera positioned to capture a view of at least one of two axles; or an accelerometer attached to one of the two axles; and the sensor data captures a suspension response to a driving event; determining, using a machine-learning model, whether the suspension response correlates to a failing state of a component of a suspension system; and when the suspension response is correlated to the failing state, performing a mitigation action based on the correlated failing state.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1A is a top view diagram of a vehicle in which a suspension health monitor may be implemented according to examples;

FIG. 1B is a schematic diagram of certain the components of the vehicle of FIG. 1A;

FIGS. 2A-2D depict various configurations of example sensors that collect sensor data for monitoring suspension system health according to an example;

FIG. 3 is a flow diagram illustrating a method to provide suspension health monitoring according to examples; and

FIG. 4 is a block diagram illustrating example physical components of a computing device or system with which examples may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. The following detailed description is, therefore, not to be taken in a limiting sense.

The present disclosure relates to systems and methods of providing suspension health monitoring in a vehicle according to examples. In examples, suspension health monitoring includes applying a machine-learning model to collected sensor data for detecting patterns of behavior that can be correlated to a failing state of a component of the suspension system of the vehicle. The machine-learning model may be trained to detect various stages of a failing state. For instance, the machine-learning model may be able to detect an early stage or a later stage of a failing state of a suspension system component that may be mitigated to prevent further failure and/or performance and safety issues.

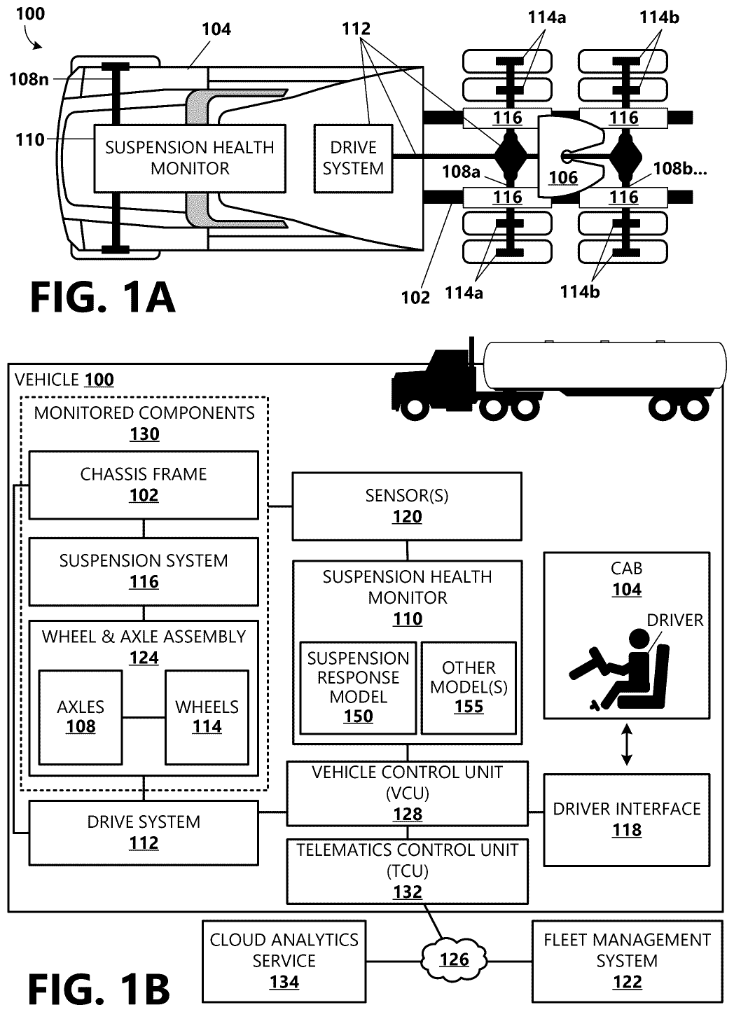

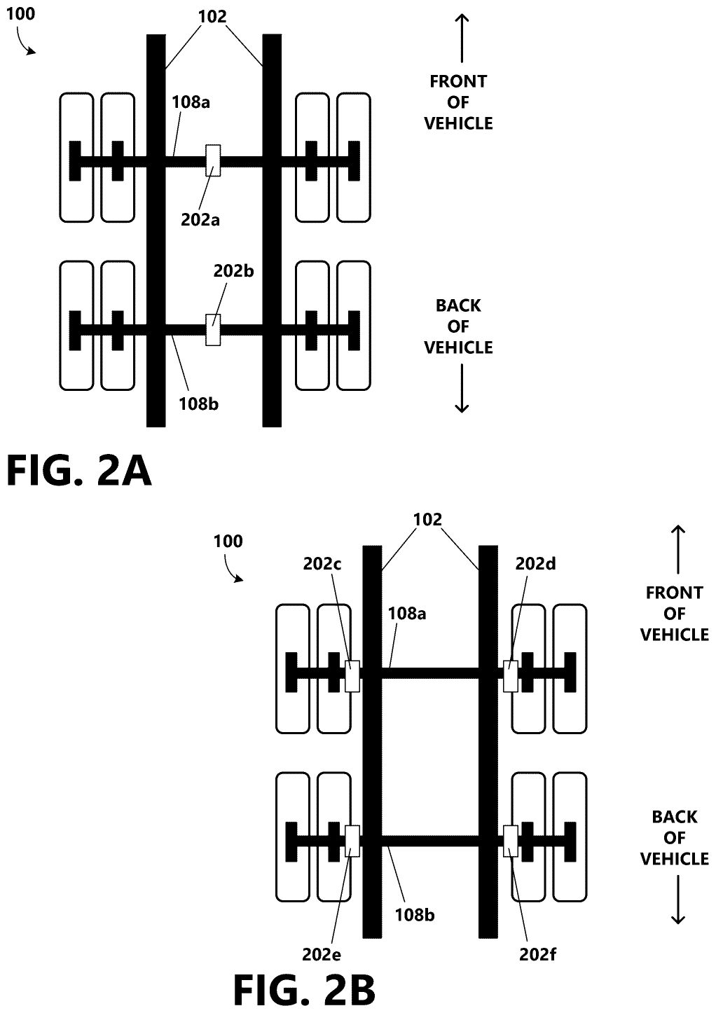

FIGS. 1A and 1B are schematic diagrams of an example vehicle 100 in which suspension health monitoring may be implemented according to examples of the present disclosure. In some implementations, the vehicle 100 is a truck, such as a Class 8 truck. However, the methods and systems can be used by vehicles 100 of different types and/or sizes. For instance, aspects of the disclosed subject matter may have wide application and, therefore, may be suitable for use with other types of vehicles, such as passenger vehicles, buses, light, medium, and heavy-duty vehicles, motor homes, etc. Accordingly, the following descriptions and illustrations herein should be considered illustrative in nature and, thus, not limiting of the scope of the claimed subject matter. In some implementations, the vehicle 100 is included in a fleet of vehicles owned, operated, and/or managed by a single organization, company, government agency, etc., (referred to herein as a fleet entity). In examples, the vehicle 100 and the other vehicles in the fleet may be assembled to serve a common purpose or function (e.g., transportation of goods, personnel, public transportation, delivery services, emergency services). In further examples, the fleet entity includes a fleet management system 122 operating on and/or including a computing device (e.g., of a back-office). The vehicle 100 (and other vehicles in the fleet) may include a telematics control unit 132, where the telematics control unit 132 includes one or more communication interfaces for establishing connections with cloud-based servers or services via one or a combination of networks 126 (e.g., cellular networks, Wi-Fi, and/or other connectivity options). For instance, the telematics control unit 132 may allow the vehicle 100 (and other vehicles in the fleet) to communicate with the fleet management system 122, a cloud analytics service 134, and/or other endpoints via the established connections.

As depicted in FIG. 1A, the vehicle 100 includes a cabin (referred to herein as cab 104) mounted to a chassis frame 102 that serves as a main support structure for the vehicle 100. In some examples, a driver may occupy the cab 104 to operate/drive the vehicle 100. In other examples, the vehicle 100 has autonomous driving capabilities and does not include a driver. The chassis frame 102 may include a plurality of frame rails and crossmembers. In some examples, the chassis frame 102 is connected to a trailer by a trailer coupling 106, such as, for example, a “fifth wheel,” to form a tractor-trailer combination.

In examples, the vehicle 100 includes one or more wheel and axle assemblies 124 comprising one or more axles 108a-108n (collectively, axles 108) coupled to at least one pair of wheels 114a-114n (collectively, wheels 114) onto which tires are mounted that interact with a driving surface. In an example 6×4 configuration, two of the axles 108 are drive axles that are powered by a drive system 112 to propel the vehicle 100. In some implementations, and as depicted in FIG. 1A, each drive axle 108 may be coupled to two pairs of wheels 114 (e.g., one pair on a left side of the vehicle 100 and one pair on a right side of the vehicle); however, in other examples, other wheel and drive configurations are contemplated. The drive system 112 includes various components that generate power and transmit the power to the drive axles 108. For instance, the drive system 112 includes various components, such as at least one power source, such as an internal combustion engine and/or battery and electric motor, transmission, and differentials. In some implementations, the drive axles 108 are electric axles (e-axles) that have an electric motor integrated in or connected to the axles that transmit torque to the wheels 114 to propel the vehicle 100 forward or backward. The electric motors may have an integrated transmission and be used alone to power the wheels 114, or be used in combination with a mechanical drivetrain, where the power is transmitted from the power source to the wheels 114 through a combination of gears, driveshafts, and differentials. In some examples, the drive axles 108 may include an electric motor operatively connected to a left side and another electric motor operatively connected to a right side of each axle such that torque may be controlled separately to each side of the drive axles 108.

In examples, the vehicle 100 further includes a suspension system 116 including various components that connect the chassis frame 102 to the wheel and axle assembly 124. The suspension system 116 may include linkages and one or a combination of spring suspension components, air suspension components, and equalizing beam components that stabilize the vehicle 100, cushion the chassis frame 102 (and vehicle occupants) from an irregular road surface (e.g., absorb shocks and vibrations from the road), and maintain proper axle 108 spacing and alignment. In examples, the design of the suspension system 116 may provide isolation of motion of the chassis frame 102 from the wheel and axle assembly 124 (e.g., that would otherwise be transferred from the wheels 114 to the chassis frame 102) while maintaining stability of the vehicle 100 and providing desirable handling characteristics. In some implementations, the suspension system 116 includes a leaf spring, air spring, and shock absorber. For instance, each end of each axle 108 may be mounted at or approximate to the center of a leaf spring, where the leaf spring may have a forward end mounted to the chassis frame 102 so that the leaf spring may pivot in a vertical plane perpendicular to the road surface. An air spring may connect the rear end of the leaf spring to the chassis frame 102. A shock absorber may be also coupled between the leaf spring or axle 108 and the chassis frame 102. For instance, flexing of the leaf spring combined with the operation of the air spring and shock absorber may isolate and dampen vertical motion of the wheels 114 as they negotiate the roadway, thereby providing a smoother ride.

According to aspects of the present disclosure, the vehicle 100 includes a suspension health monitor 110 for providing suspension health monitoring. In examples, the suspension health monitor 110 analyzes sensor data collected from one or more sensors 120 included on the vehicle 100 to determine whether a suspension system response to a driving event indicates the suspension system 116 is in a healthy state or whether the suspension system 116 is in a failing state. In examples, “healthy state” is a condition of the suspension system 116 when it is functioning in accordance with its intended design or specifications. When the suspension system 116 is in a healthy state, the suspension system 116 may be absent of dysfunction or component failure and suspension responses of the suspension system 116 to driving events are within defined thresholds. In further examples, a “failing state” may include a range of conditions, from early stages of compromised functionality to a later stage of full failure. For instance, later stages of the failing state may produce suspension responses that are outside defined thresholds, while earlier stages of the failing state may produce suspension responses within defined thresholds, but where one or more components of the suspension system 116 may have damage, wear, or are otherwise compromised where the component(s) are progressing towards a point of losing their ability to function effectively or as intended. In some implementations, the failing state may further correspond to a determined type, criticality factor, and/or safety factor of component failure or compromise.

In some implementations, the driving event is a dynamic interaction between the vehicle 100 and a driving surface during operation of the vehicle 100. The driving event may include a discrete event, such as acceleration, deceleration, turning, encountering a driving surface condition, such as an obstacle or road irregularity, a change in driving surface conditions, etc., or a non-discrete event, such as a time period of driving. In examples, the driving event causes a suspension response of the suspension system 116, which may include behavior of how the suspension components react to the driving event and ancillary effects of the reaction to other vehicle components. For instance, a suspension response to navigating a speed bump may include compression and rebound of springs or airbags in the suspension system 116, vibration damping, stabilization of the vehicle 100, etc. In some examples, a suspension response includes a pattern of movement, vibration, oscillation, temperatures, pressure variations, and/or another characteristic of behavior of one or more axles 108 that is captured by sensor data. In other examples, the suspension response includes a pattern of movement, vibration, oscillation, temperatures, pressure variations, and/or another characteristic of behavior of one or more other monitored components 130, such as the chassis frame 102 and/or one or more components of the suspension system 116 and/or the wheel and axle assembly 124.

In examples, the suspension health monitor 110 may be able to detect an early stage of a failing state of a suspension system component, where the component may have below a threshold amount of wear, degradation, fatigue, or other malfunction. In other examples, the suspension health monitor 110 detects a failing state of a suspension system component corresponds to a later stage of component failure, where the suspension system component may have an amount of wear, degradation, fatigue, or other malfunction above the threshold. A failing component may deteriorate ride quality (e.g., comfort), affect the vehicle's ability to handle sudden maneuvers and maintain proper tire contact with the driving surface, reduce the lifespan of other vehicle components that may result in premature and/or extraneous repairs or replacements, etc.

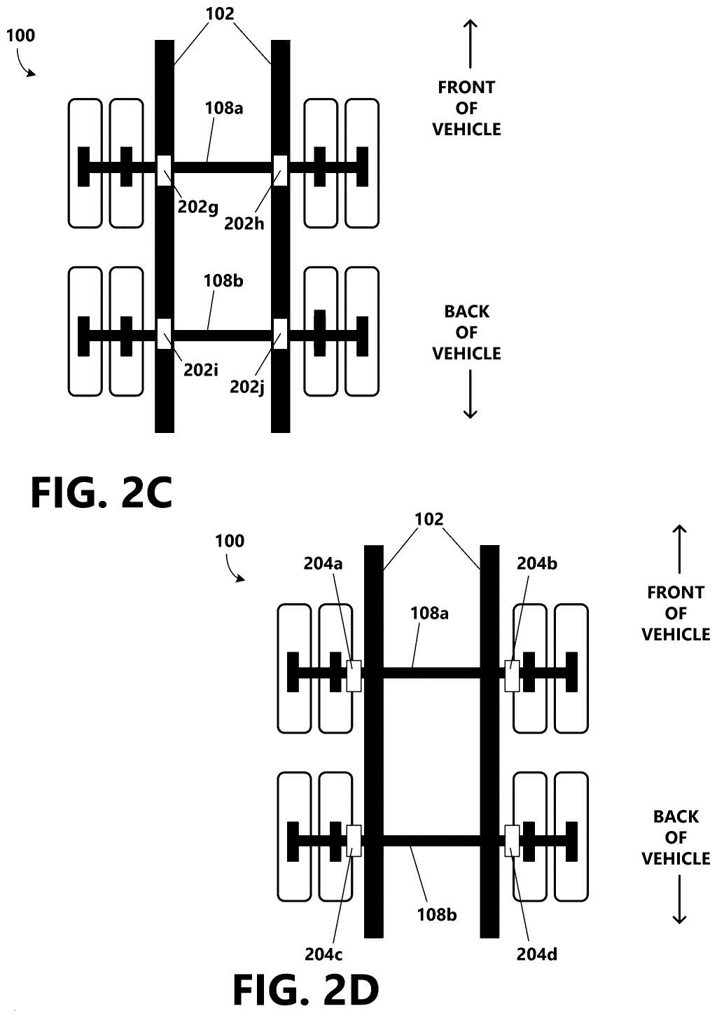

In some implementations, the sensors 120 include at least one camera. In some implementations, the sensors 120 include at least one accelerometer (e.g., in addition to, or instead of, a camera). The at least one camera and/or accelerometer are described in further detail below with reference to FIGS. 2A-2D. Other types of sensors 120 may further be included, such as wheel speed sensors, engine speed sensors, temperature sensors, pressure sensors, cameras, accelerometers, Radar, LiDAR (Light Detection and Ranging), GPS (Global Positioning System), ABS (Anti-lock Braking System) sensors, stability control system sensors, and/or other devices that monitor different aspects of the vehicle's behavior, driver's behavior, and/or environment. For example, sensor data may include real-time data on vehicle speed, acceleration, braking, battery state of charge, GPS location, external temperature, weather conditions, terrain, driving conditions, and/or other dynamic factors. In some examples, the sensors 120 are located on an underside of the vehicle 100 and positioned to collect measurements related to a driving event and/or the suspension system's response to the driving event. Measurements related to the suspension response may include measurements of one or more monitored components 130 of the vehicle 100. Example suspension response measurements may include measurements of movement, vibration, oscillation, temperatures, pressure variations, and/or another suspension response behavior characteristic. In further examples, the sensors 120 collect measurements about the driving event, such as measurements or conditions of the driving surface. Example driving event measurements may include sensor readings representing time, vehicle speed, acceleration, deceleration, direction of travel, grade of the driving surface, driving surface conditions, characteristics of a driving surface obstacle, and/or other characteristics of the driving event.

According to examples, the suspension health monitor 110 includes or is in communication with a suspension response model 150, where the model is a mathematical representation of various suspension responses to various driving events and conditions. In some implementations, the suspension response model 150 represents behavior characteristics of the axles 108 during a suspension response. Axle behavior characteristics may include movement (e.g., oscillation, vibration), temperature, or other axle behavior characteristics related to a suspension system 116 in a healthy state and in various stages of a failing state. In other implementations, the suspension response model 150 further represents behavior characteristics of other monitored components 130 during a suspension response to a driving event. In examples, the suspension response model 150 is a machine learning (ML) model that learns from and makes decisions or predictions based on historical training data and/or real-time data. The suspension response model 150 may use algorithms to parse training data, learn from that training data, and then apply what has been learned to make informed decisions. In examples, the suspension response model 150 is initialized with parameters and characteristics of the vehicle 100 and the vehicle's suspension system 116 representative of the configuration of the vehicle 100 and the suspension system 116. The parameters and characteristics may include various elements such as a spring constant, damping coefficient, effective mass, natural frequency, and range of travel of the suspension components in relation to each axle 108 and, in some examples, in relation to each end of each axle 108. The parameters and characteristics may further include the Gross Vehicle Weight Rating (GVWR) of the vehicle 100 and the vehicle's dry weight. In examples, the parameters and characteristics can be specific to a particular vehicle 100, a model of vehicle 100, a group of similar vehicles (e.g., class 8 trucks), or a broader set of vehicles 100.

In some examples, the suspension response model 150 is trained using training data, where the training data (e.g., training, validation, and testing data) includes data obtained from testing one or more test vehicles in various test driving conditions. In test driving conditions, a test vehicle is operated in a controlled environment and subjected to various loads, driving conditions, suspension system component health states, and driving events, where sensor data is recorded and used as the training data. In some examples, the training data is annotated. For instance, data points may be labeled corresponding to the health state (e.g., healthy, failing, and/or a stage of the failing state) of different components of the suspension system 116. In further examples, the training data includes sensor data obtained from the vehicle 100 or other similar vehicles operating in real-world environments. The training may be supervised learning, semi-supervised learning, unsupervised learning, reinforcement learning, and/or the like, including combinations and/or multiples thereof.

According to an example implementation, the suspension response model 150 may be trained to identify axle behavior patterns in the training data that correspond to known healthy states of the suspension system 116. For instance, the training data may include sensor readings representing characteristics of axle behavior when the test vehicle's suspension system 116 (e.g., components of the suspension system) is in a healthy state. When the suspension system 116 is a healthy state, the axles 108 may exhibit certain predictable behavior patterns in the suspension system's response to various driving events and under certain conditions (ambient temperature, vehicle load, road grade, etc.). In examples, the suspension response model 150 may be further trained to identify axle behavior patterns that correspond to known failing states of one or more components of the suspension system 116. These patterns may include specific movement, vibration frequencies, temperatures, or other identifiable axle behavior characteristics corresponding to different stages of a failing state of one or more specific suspension system components. For instance, a cracked leaf spring in a particular location on the vehicle 100 may cause a axle 108 to exhibit a pattern of behavior (e.g., vibration or movement) that is represented in collected sensor data, where the suspension response model 150 may be trained to identify the specific axle behavior pattern. The suspension response model 150 may be further trained to correlate the identified axle behavior pattern to the specific failing component (e.g., the cracked leaf spring) and, in some examples, to a stage of failure of the specific failing component. The specific axle behavior pattern, for instance, may differ from another axle behavior pattern exhibited by the same axle 108 (and/or another axle 108) when the leaf spring is deformed rather than cracked), when a shock absorber is experiencing internal wear or fluid leakage, when an air bag has a leak or worn seal, and/or other example failing states of a suspension system component. The suspension response model 150 may be trained using the training data, tested and evaluated, and tuned for accuracy. Once trained, the suspension health monitor 110 is operative to detect axle behavior patterns that correspond to a healthy state of the suspension system 116 and/or to detect axle behavior patterns that correspond to a failing state of a suspension system component by applying the suspension response model 150 to new sensor data (e.g., real-world, non-training data). By comparing observed axle behavior with learned patterns of healthy and/or failing states, the suspension health monitor 110 may be able to predict failures before they escalate into further damage or safety risks. An ability to detect a failing state of a suspension system component may be desirable for providing optimal vehicle performance and safety.

In some implementations, when a failing state of a suspension system component 130 is identified, the suspension health monitor 110 may further determine an action to perform to mitigate the failing component. In further implementations, the suspension health monitor 110 may further cause the action to be performed to improve the vehicle's performance and safety. The action may be communicated to a vehicle control unit (VCU) 128 that integrates and controls various electronic systems within the vehicle 100, such as a driver interface 118, engine control unit, transmission control unit, brake system, the suspension system 116, etc.

In some examples, the action includes generating an alert or diagnostic code to notify the driver, the fleet management system 122, the cloud analytics service 134, maintenance personnel and/or a maintenance system, and/or a driver of another vehicle of the vehicle fleet about the failing component. In some examples, the driver may be alerted via a visual and/or audible notification. For instance, the alert may be communicated to the driver via the driver interface 118, such as a dashboard display, an infotainment screen, a warning light, a warning indicator, etc. In some examples, the alert is formatted and displayed based on a stage of the failing state, a type, criticality factor, and/or safety factor of the suspension system component failure or compromise. In further examples, the suspension health monitor 110 may further determine a recommended driver action (e.g., an action for the driver to perform) based at least in part on the stage of the failing state, a type, criticality factor, and/or safety factor of the suspension system component failure or compromise and include the recommended driver action in the alert to the driver. In examples, the recommended driver action may be determined to help mitigate the failing state of the suspension system 116. For instance, some recommended driver actions include taking righthand or lefthand turns more slowly, lessen acceleration or deceleration, schedule maintenance, to make an adjustment (e.g., positioning of the trailer coupling 106 to reduce load on a compromised axle 108), to stop operating the vehicle 100 immediately, etc.

In other examples, the action includes automatically controlling a vehicle function to mitigate the failing state of the suspension system 116. In some examples, the suspension health monitor 110 may communicate the detected failing state to the VCU 128, which, in response, may control the vehicle's drive system 112 to regulate power flow to particular axles 108 and/or wheels 114, control the suspension system 116 to inflate or deflate one or more air springs, adjust dynamic damping, adjust suspension stiffness (e.g., load levelling), or perform another automated action to mitigate the failing suspension system 116. In further examples, the suspension health monitor 110 may cause sensor data associated with the detected failing state to be recorded (e.g., for training data, warranty data, and/or root cause analysis).

In some implementations, the action includes causing an alert about the failing state of the suspension system 116 to be communicated to the fleet management system 122. In some examples, the fleet management system 122 may provide a user interface via which the alert is presented to a user. In other examples, the fleet management system 122 may perform one or more automated actions, such as scheduling the vehicle 100 for service or maintenance, initiating an order of a replacement for the failing suspension system component, collecting suspension health data from other vehicles in the fleet, etc.

In some implementations, the suspension health monitor 110 may include or may be in communication with one or more other ML models 155. One example other model 155 includes a body roll model representing roll behavior (e.g., tilting) of the vehicle 100 while maneuvering a driving event (e.g., a turn) at various radial acceleration values and various load distributions. In some examples, the represented roll behavior corresponds to a suspension system 116 in a healthy state. In other examples, the represented roll behavior corresponds to a suspension system 116 in a failing state. In examples, sensor data may be collected that represents roll behavior of the vehicle 100 in a turn, such as a yaw rate, acceleration along different axes, tilt angle, wheel speed, load distribution, etc. The body roll model may be applied to the collected sensor data to analyze the data and determine whether observed roll behavior matches expected roll behavior of a healthy suspension system 116 or a failing state of the suspension system 116. For instance, when observed roll behavior does not match expected roll behavior of a healthy suspension system 116, a mitigation action may be determined. In some examples, the suspension health monitor 110 may further cause the mitigation action to be performed. Some example mitigation actions include notifying the driver, inflating or deflating one or more air springs, adjusting dynamic damping, adjusting a driving mode, adjusting suspension stiffness (e.g., load levelling), or performing another automated action to mitigate the failing suspension system 116.

In further implementations, one or more other models 155 are trained to detect failing states associated with other health issues of other monitored components 130. For instance, the one or more additional models may be trained based on sensor readings corresponding to the other health issues, such as axle hop events, debris accumulation, fluid leakage, worn brake shoes, excessive slack travel in the vehicle's braking system, out-of-range temperature measurements (e.g., brakes, U-joints, and/or fluids), etc. The one or more additional models may be applied to sensor data collected from the vehicle's sensors to identify whether observed sensor readings match expected behavior of a healthy state or a failing state of the other monitored components 130. When a failing state associated with a health issue is detected, the suspension health monitor 110 may further determine a mitigation action for the health issue and cause the mitigation action to be performed.

FIGS. 2A-2D depict various configurations of example sensors 120 that collect sensor data for monitoring suspension system health according to an example. As mentioned above, in some implementations, the sensors 120 include at least one camera 202a-202j (collectively, camera 202). The camera 202 may be a high-fidelity camera designed to capture images with a high degree of accuracy and detail. The camera 202 may further capture images at a high frame rate. In some examples, the camera 202 includes a wide-angle lens. In some implementations, the camera 202 captures movement of one or more axles 108 relative to the chassis frame 102 and or driving surface. In other implementations, the camera 202 includes an infrared camera operative to capture images within the infrared spectrum. For instance, an infrared camera may capture temperature changes of one or more axles 108, brake components, U-joints, fluids, etc. In further implementations, the camera 202 captures images in the visible spectrum of specific components of the suspension system 116, the axles 108, wheels 114, and/or other monitored components 130. In further examples, the camera 202 may be positioned to capture conditions of the driving surface. For instance, conditions of the driving surface may provide details about the driving event (e.g., size of a pothole or speed bump, road grade, weather conditions). The captured image data may be analyzed by the suspension health monitor 110 to detect a correlation of the data to a failing state of the suspension system 116 and/or other monitored components 130.

With reference now to FIG. 2A, an example camera 202 configuration is described that captures movements of two axles 108. Other example configurations may include additional or fewer cameras 202 that capture movements of additional or fewer axles 108. In some implementations, a first camera 202a may be located and positioned to capture movements of a first axle 108a relative to a reference point (e.g., at least a portion of the chassis frame 102 supported by the first axle 108a, a second axle 108b, another axle 108, and/or the driving surface). In some examples, the first camera 202a may additionally capture movements of the second axle 108b relative to a reference point (e.g., at least a portion of the chassis frame 102 supported by the second axle 108b, the first axle 108a, another axle 108, and/or the driving surface). In other examples, a second camera 202b may be located and positioned to capture movements of the second axle 108b relative to a reference point. In some implementations, the first camera 202a may be attached to the first axle 108a and the second camera 202b may be attached to the second axle 108b. In other examples, the first camera 202a may be attached to the chassis frame 102 or other component above the first axle 108a and the second camera 202b may be attached to the chassis frame 102 or other component above the second axle 108b.

With reference now to FIG. 2B, in some implementations, at least two cameras 202c, 202d, 202e, and 202f may be attached to (or on the chassis frame 102 or other component above) each axle 108a and 108b. For instance, a first camera 202c may be attached towards a first end of the first axle 108a that captures movements of the first end of the first axle 108a and a second camera 202d may be attached towards a second end of the first axle 108a that captures movements of the second end of the first axle 108a. Movements of the first end and the second end of the first axle 108a may be captured relative to the chassis frame 102, the other end of the first axle 108a, and/or a first and/or second end of the second axle 108b. Additionally, a third camera 202e may be attached towards a first end of the second axle 108b that captures movements of the first end of the second axle 108b and a fourth camera 202f may be attached towards a second end of the second axle 108b that captures movements of the second end of the second axle 108b. In some examples, movements of the first end and the second end of the second axle 108b may be captured relative to the chassis frame 102, the other end of the second axle 108b, the first and/or second end of the first axle 108a, another axle 108, and/or the driving surface.

With reference now to FIG. 2C, in some implementations, one or more cameras 202g, 202h, 202i, and/or 202k may be attached to the chassis frame 102 and may capture movements of one or more axles 108a and/or 108b relative to one or more portions of the chassis frame 102 and/or driving surface. In other implementations, at least one camera 202 captures images of at least a portion of the suspension system 116. In yet other implementations, the camera(s) 202 are located elsewhere on the vehicle 100 to capture images that can be analyzed by the suspension health monitor 110 for identifying a failing state of the suspension system 116.

With reference now to FIG. 2D, in some implementations, the sensors 120 include at least one accelerometer 204a, 204b, 204c, and/or 204d (collectively, accelerometer 204) used to collect measurements of one or more axle behavior characteristics (e.g., movement, vibrations) in a driving event. In some examples, the accelerometer(s) 204 may be used to enhance accuracy, performance, and/or reliability of camera readings for enabling the suspension health monitor 110 to better detect failing state patterns that may be correlated to a failing state of a suspension system component or other monitored component 130. In some examples, an accelerometer 204 is located and positioned on each axle 108. In further examples, an accelerometer 204 may be attached towards the end of each axle 108 and capture motion and vibration measurements of the end of each axle 108. In yet further examples, one or more accelerometers 204 may be attached to one or more other monitored components 130 where a pattern of motion or vibration may be detected and correlated to a failing state of the suspension system 116 and/or one or more other monitored components 130.

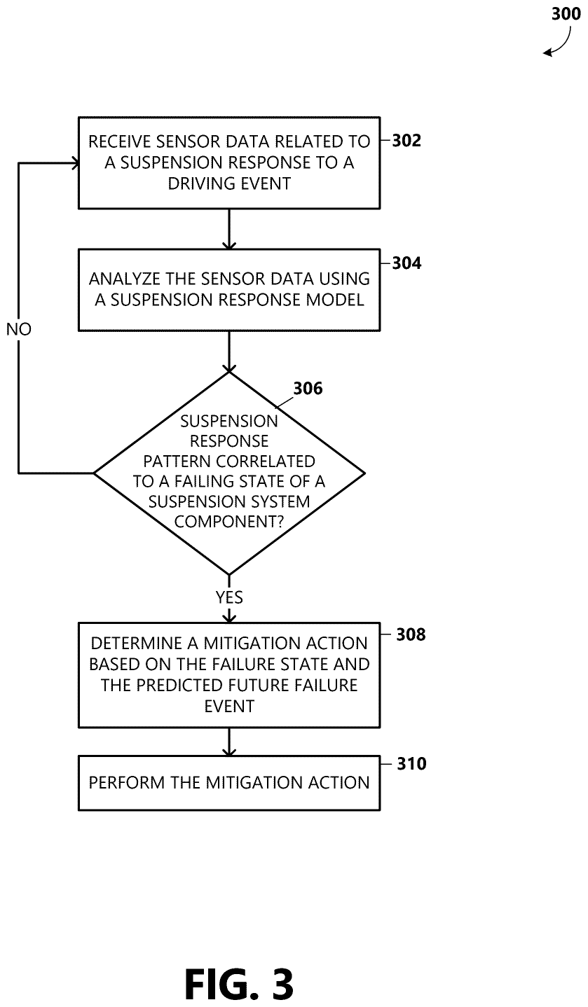

With reference now to FIG. 3, a flow diagram is provided illustrating processing steps of an example method 300 that can be used to provide suspension health monitoring. At operation 302, various sensor data may be received. For example, the suspension health monitor 110 may receive signals from one or more sensors 120 related to a suspension response to a driving event. The one or more sensors 120 may include a camera 202 and/or an accelerometer 204 operative to capture measurements of motion. In some examples, the camera(s) 202 may capture additional data (e.g., temperature measurements, images of one or more monitored components 130, and/or other data). The driving event may be a discrete event, such as acceleration, deceleration, turning, encountering a driving surface condition, such as an obstacle or road irregularity, a change in driving surface conditions, etc., or a non-discrete event, such as a time period of driving. In some examples, some characteristics about the driving event are pre-known (e.g., dimensions of a known obstacle or road irregularity, a known road grade, a known curve, etc.). In further implementations, captured sensor data includes information about the driving event.

At operation 304, the sensor data is analyzed. In some implementations, the suspension health monitor 110 applies a suspension response model 150 to the sensor data, where the model is trained to detect patterns in the sensor data that may correspond to a failing state of a component of the suspension system 116. In some examples, the sensor data is analyzed to detect patterns in behavior of the axles 108 during the suspension response. Axle behavior may include movement (e.g., oscillation, vibration), temperature, or other behavior characteristics. In some examples, the suspension health monitor 110 applies one or more other models 155 to collected sensor data to detect patterns in the sensor data that correspond to a health state of one or more other monitored components 130.

At decision operation 306, a determination is made as to whether a detected pattern of sensor data may correspond to a healthy state or to one of various stages of a failing state of one or more components of the suspension system 116 or another monitored component 130. The various stages may be based on an amount of compromise and/or a severity of impact of failure of a compromised component.

When a determination is made that a detected pattern of sensor data is correlated to a failing state of a suspension system component or other monitored component 130, the method 300 proceeds to operation 308, where a mitigation action is determined that may help mitigate effects and/or worsening of the failing or compromised component. The determined mitigation action may be determined based on a determined stage of failure.

In some examples, the mitigation action includes generating an alert or diagnostic code to notify the driver, the fleet management system 122, the cloud analytics service 134, maintenance personnel and/or a maintenance system, and/or a driver of another vehicle of the vehicle fleet about the failing state. In some examples, the driver may be alerted via a visual and/or audible notification presented by a driver interface 118. In further examples, the alert/notification may include a recommended driver action for the driver to perform to help mitigate effects and/or worsening of the failing or compromised component. For instance, the alert/notification may recommend for the driver to adjust a vehicle maneuver (e.g., acceleration, deceleration, and/or turning the vehicle 100), schedule maintenance, make an adjustment (e.g., positioning of the trailer coupling 106 to reduce load on a compromised axle 108), stop operating the vehicle 100, etc.

In other examples, the mitigation action includes automatically controlling a vehicle function to mitigate the failing state of the suspension system component. Some example vehicle functions that may be automatically controlled may include regulating power flow to particular drive axles 108 and/or wheels 114, adjusting a drive control method, inflating or deflating one or more air springs, adjusting dynamic damping, adjusting suspension stiffness (e.g., load levelling), or performing another automated action to mitigate the failing suspension system 116. In further examples, the mitigation action includes recording the collected sensor data (e.g., for training data for the suspension response model 150 and/or other models 155, warranty data, and/or root cause analysis). At operation 310, the mitigation action may be performed.

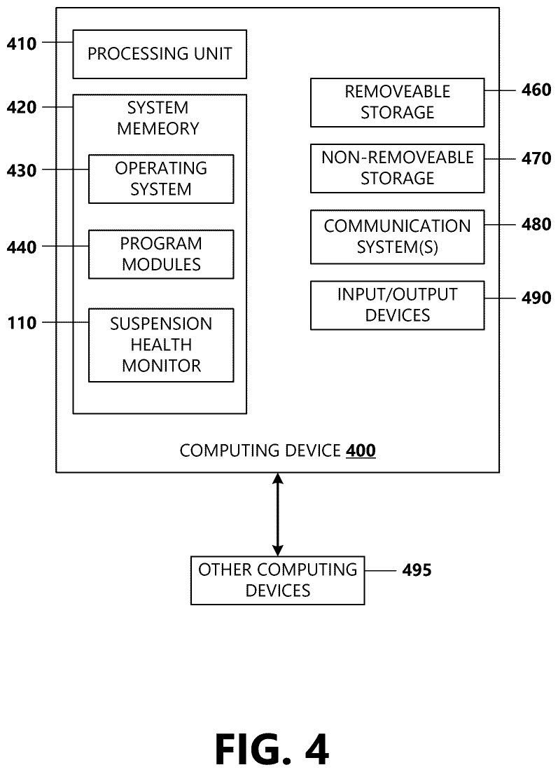

FIG. 4 is a system diagram of a computing device 400 according to an example. As shown in FIG. 4, the physical components (e.g., hardware) of the computing device 400 are illustrated and these physical components may be used to practice the various aspects of the present disclosure. The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400 and one or more program modules 440. The program modules 440 may be responsible for performing one more of the operations of the methods described above for providing robust network connectivity. A number of different program modules and data files may be stored in the system memory 420. While executing on the processing unit 410, the program modules 440 may perform the various processes described above. One example program module 440 includes sufficient computer-executable instructions for the suspension health monitor 110.

The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, routing engines, gateways, signings systems and the like. Examples of communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 400. Any such computer storage media may be part of the computing device 400. Computer storage media does not include a carrier wave or other propagated or modulated data signal.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A vehicle, comprising:
a chassis frame;
a wheel and axle assembly comprising at least two axles and at least two sets of wheels;
a suspension system connected to the chassis frame and the wheel and axle assembly;
at least one sensor, comprising one of:
a camera positioned to capture a view of at least one of the two axles; or
an accelerometer attached to one of the two axles; and
a suspension health monitor, comprising:
at least one processing unit; and
a memory including instructions, which when executed by the at least one processing unit, cause the suspension health monitor to:
receive sensor data from the at least one sensor, where the sensor data captures a suspension response to a driving event;
determine, using a machine-learning model, whether the suspension response correlates to a failing state of the suspension system; and
when the suspension response is correlated to the failing state, perform a mitigation action based on the correlated failing state.

2. The vehicle of claim 1, wherein the suspension response comprises a pattern of axle behavior.

3. The vehicle of claim 2, wherein the pattern of axle behavior includes a pattern of movement of at least one of the two axles.

4. The vehicle of claim 2, wherein:
the camera is an infrared camera; and
the pattern of axle behavior includes a pattern of temperature changes of at least one of the two axles.

5. The vehicle of claim 2, wherein using the machine-learning model to determine whether the suspension response correlates to the failing state of the suspension system comprises using the machine-learning model to determine whether the pattern of axle behavior correlates to a pattern of a failing state of at least one component of the suspension system.

6. The vehicle of claim 5, wherein:
the failing state is associated with one of a plurality of stages ranging from an early stage of failure of the at least one component to a later stage of failure of the at least one component; and
the mitigation action is determined based on the stage associated with the failing state.

7. The vehicle of claim 5, wherein the at least one component of the suspension system comprises:
a leaf spring;
an air spring; or
a shock absorber.

8. The vehicle of claim 1, wherein the mitigation action comprises:
generating an alert about the failing state of the suspension system; and
communicating the alert to at least one of:
a driver of the vehicle;
a fleet management system;
a cloud analytics service;
maintenance personnel; or
a driver of another vehicle of a vehicle fleet comprising the vehicle.

9. The vehicle of claim 1, wherein the mitigation action comprises automatically controlling a vehicle function.

10. The vehicle of claim 1, wherein:
the driving event is a discrete event comprising at least one of:
acceleration;
deceleration;
turning; or
encountering a driving surface condition; and
the sensor data includes data about the driving event.

11. The vehicle of claim 1, wherein the driving event is a non-discrete event including a time period of operating the vehicle.

12. The vehicle of claim 1, wherein
the camera includes a plurality of cameras; and
at least one of the plurality of cameras is located on at least one of the two axles; or
at least one of the plurality of cameras is located on the chassis frame.

13. The vehicle of claim 12, wherein:
at least one of the plurality of cameras captures movement of at least one of the two axles relative to the chassis frame; or
at least one of the plurality of cameras captures movement of a first axle of the two axles relative to movement of a second axles of the two axles.

14. The vehicle of claim 1, wherein:
the camera is a first camera;
the machine-learning model is a first machine-learning model;
the failing state of the suspension system is a first failing state;
the at least one sensor comprises a second camera positioned to capture a view of at least one of:
the suspension system; or
at least one of the at least two sets of wheels; and
the instructions further cause the suspension health monitor to:
determine, using the second machine-learning model, whether the sensor data correlates to a second failing state of the at least one of:
the suspension system; or
or at least one of the at least two sets of wheels; and
when the suspension response is correlated to the second failing state, performing a mitigation action based on the correlated second failing state.

15. A method for providing suspension health monitoring in a vehicle, comprising:
receiving sensor data from at least one sensor, wherein:
the at least one sensor comprises one of:
a camera positioned to capture a view of at least one of two axles included in the vehicle; or
an accelerometer attached to one of the two axles; and
the sensor data captures a suspension response to a driving event;
determining, using a machine-learning model, whether the suspension response correlates to a failing state of a suspension system of the vehicle; and
when the suspension response is correlated to the failing state, performing a mitigation action based on the correlated failing state.

16. The method of claim 15, wherein the suspension response comprises a pattern of axle behavior comprising at least one of:
a pattern of movement of at least one of the two axles; or
a pattern of temperature changes of at least one of the two axles.

17. The method of claim 16, wherein determining whether the suspension response correlates to the failing state of the suspension system comprises using the machine-learning model to determine whether the pattern of axle behavior correlates to a pattern of the failing state of at least one component of the suspension system.

18. The method of claim 17, wherein determining whether the suspension response correlates to the failing state of the suspension system comprises:
determining the failing state is associated with one of a plurality of stages ranging from an early stage of failure of the at least one component to a later stage of failure of the at least one component of the suspension system; and
the mitigation action is determined based on the stage associated with the failing state.

19. The method of claim 17, wherein the at least one component of the suspension system comprises:
a leaf spring;
an air spring; or
a shock absorber.

20. A suspension health monitor, comprising:
at least one processing unit; and
a memory including instructions, which when executed by the at least one processing unit, cause the suspension health monitor to perform operations comprising:
receiving sensor data from at least one sensor, wherein:
the at least one sensor comprises one of:
a camera positioned to capture a view of at least one of two axles;
or
an accelerometer attached to one of the two axles; and
the sensor data captures a suspension response to a driving event;
determining, using a machine-learning model, whether the suspension response correlates to a failing state of a component of a suspension system; and
when the suspension response is correlated to the failing state, performing a mitigation action based on the correlated failing state.
